(19) United States
(12) Patent Application Publication
(10) Pub. No.: US 2006/0218594 A1
(43) Pub. Date: Sep. 28, 2006

(54) Dual-function transmitting system

(76) Inventors: Hsi-Mien B. Wu, Hsin-Tien City (TW); Chia-Ming Liu, Hsin-Tien City (TW)

Correspondence Address: HOFFMAN WARNICK & D'ALESSANDRO, LLC, 75 STATE STREET, 14TH FLOOR, ALBANY, NY, 12207, US

(21) Appl. No.: 11/371,054

(22) Filed: Mar. 8, 2006

(30) Foreign Application Priority Data
Mar. 9, 2005 (TW) 094107214

(51) Int. Cl. H04N 7/18

(52) U.S. Cl. 725/74

(57) ABSTRACT

A dual-function transmitting system is provided. The dual-function transmitting system includes a receiving module, N combining modules, N transmitting modules, and M signal providers. After receiving a CATV signal and an Ethernet signal, the receiving module transfers the Ethernet signal into a RF signal. Each of the N combining modules combines the CATV signal and the RF signal transferred from the receiving module to generate a combined signal, respectively. Each of the N transmitting modules is coupled to one corresponding combining module and transmits the combined signal received from the corresponding combining module. Each of the M signal providers is coupled to one corresponding transmitting module, receives the combined signal transmitted from the corresponding transmitting module, and provides the CATV signal and the RF signal comprised in the combined signal, respectively.

### BACKGROUND OF THE INVENTION

1. Field of the Invention

This invention relates to a dual-function transmitting system. More specifically, this invention relates to a dual-function transmitting system capable of transmitting CATV signals and wireless network signals simultaneously.

2. Description of the Prior Art

In recent years, networks have become important media for exchanging information. In contrast with wired networks, wireless networks further broaden the area where people can connect to the internet.

Please refer to FIG. 1. FIG. 1 shows a general topology of how a wireless local area network (WLAN) is connected with the internet. The internet service provider (ISP) 10 provides channels for users to connect to the internet via ADSL/Cable modems and telephone lines/CATV cables. The access point (AP) 12 is used for transforming Ethernet signals into wireless network signals or transforming wireless network signals into Ethernet signals. The AP 12 transmits wireless network signals conforming to wireless transmitting protocols (such as IEEE 802.11a, IEEE 802.11b, or IEEE 802.11g) by antennas. As long as a user has a communication device (for example, desktop computer 13, notebook 14, PDA 15, or mobile phone 16) equipped with wireless network card, he/she can receive the wireless network signal transmitted by the AP 12 or transmits wireless network signals to the AP 12; thus, users are capable of connecting to the internet with the communication devices.

Since wireless signals would be blocked by cement walls or absorbed by metal shields, the covering zone that the AP 12 can provide RF signals is limited; the farther the distance is from the AP 12, the strength of the RF signals are weaker. In the areas out of the covering zone of the AP 12, people cannot connect to the internet via the network shown in FIG. 1. If there are too many partitions in an office or a family house, a plurality of APs are needed for providing wireless network signals everywhere. However, installing a plurality of APs not only cost a lot, but also increases the complexity of network hardware.

In prior arts, one method of transmitting network signals is integrating Ethernet signals in existing CATV architectures. Please refer to FIG. 2A. FIG. 2A shows an existing CATV architecture. The CATV architecture 20 includes a CATV signal provider 21 located at the proprietor end, a plurality of first signal splitters 22, a plurality of second signal splitters 23, and a plurality of CATV wall boxes 24. Each component in the CATV architecture 20 is connected with each other via coaxial cables. As shown in FIG. 2A, each first signal splitter 22 respectively transmits the CATV signal provided by the CATV signal provider 21 to one corresponding second signal splitter 23; each second signal splitter 23 further transmits the CATV signal to a plurality of wall boxes 24. In actual applications, each floor of an apartment may be equipped with one first signal splitter 22 and each family at one floor may be equipped with one second signal splitter 23. The wall boxes 24 are typical CATV sockets. The CATV architecture 20 shown in FIG. 2A has been very prevalent in common families.

Please refer to FIG. 2B. FIG. 2B shows the prior art which integrates Ethernet signals in an existing CATV architecture. Besides the components in FIG. 2A, FIG. 2B further includes a plurality of cable modems 25, a plurality of APs 26, and an ISP 27. The prior art previously mixes the Ethernet signals provided by the ISP 27 with the CATV signals in the CATV signal provider 21. After being transmitted to the users' ends, the Ethernet signals are split out from the mixed signals by each cable modem 25 and provided to each corresponding AP 26. Each AP 26 then transforms the Ethernet signals into RF signals. As shown in FIG. 2B, this prior art does not solve the problem of needing plural APs.

To solve aforementioned problems, this invention provides a dual-function transmitting system integrated in existing CATV architectures. The dual-function transmitting system according to this invention is capable of transmitting CATV signals and wireless network signals simultaneously and doesn't need much additional hardware. That is to say, this invention can provide wireless network signals at many different places without using a plurality of APs.

### SUMMARY OF THE INVENTION

The main purpose of this invention is providing a dual-function transmitting system capable of transmitting CATV signals and wireless network signals simultaneously.

According to the first preferred embodiment of this invention, the dual-function transmitting system includes a receiving module, N combining modules, N transmitting modules, and M signal providers. N and M are both natural numbers, and M is larger than or equal to N. The receiving module receives a CATV signal and an Ethernet signal and then transforming the Ethernet signal into a RF signal. Each combining module is respectively coupled to the receiving module and combines the CATV signal and the RF signal received from the receiving module to generate a combined signal, respectively. Each of the N transmitting modules is coupled to one corresponding combining module via coaxial cable, receives the combined signal from the corresponding combining module, and further transmits the combined signal to at least one signal provider. After receiving the combined signal from the transmitting modules, each signal provider provides the CATV signal and the RF signal included in the combined signal, respectively, wherein the RF signal is a wireless network signal.

According to the second preferred embodiment of this invention, the dual-function transmitting system includes a receiving module, a transmitting module, a first signal provider, a second signal provider, and a combining module. The receiving module receives an Ethernet signal and transforming the Ethernet signal into a RF signal. The transmitting module receives a CATV signal and transmitting the CATV signal. The first signal provider and the second signal provider respectively receives and provides the CATV signal transmitted by the transmitting module. The combining module is used for receiving the RF signal from the receiving module, transmitting the RF signal to the first signal provider, and for receiving and transmitting the CATV signal provided by the first signal provider. After receiving the RF signal transmitted from the combining module, the first signal provider transmitted the RF signal to the transmitting module; after receiving the RF signal transmitted from the first signal provider, the transmitting module transmits the RF signal to the at least one second signal provider.

The dual-function transmitting systems in first and second preferred embodiments are both integrated in existing CATV architectures and don't need much additional hardware. Accordingly, compared with prior arts, the dual-function transmitting systems according to this invention are convenient and inexpensive. The main difference between the first and second preferred embodiments is that the former is more suitable for a whole building or a large space and the latter is more suitable for a single family house with several rooms.

The advantage and spirit of the invention may be understood by the following recitations together with the appended drawings.

### BRIEF DESCRIPTION OF THE APPENDED DRAWINGS

FIG. 1 shows a general topology of how a wireless local area network is connected with the internet.

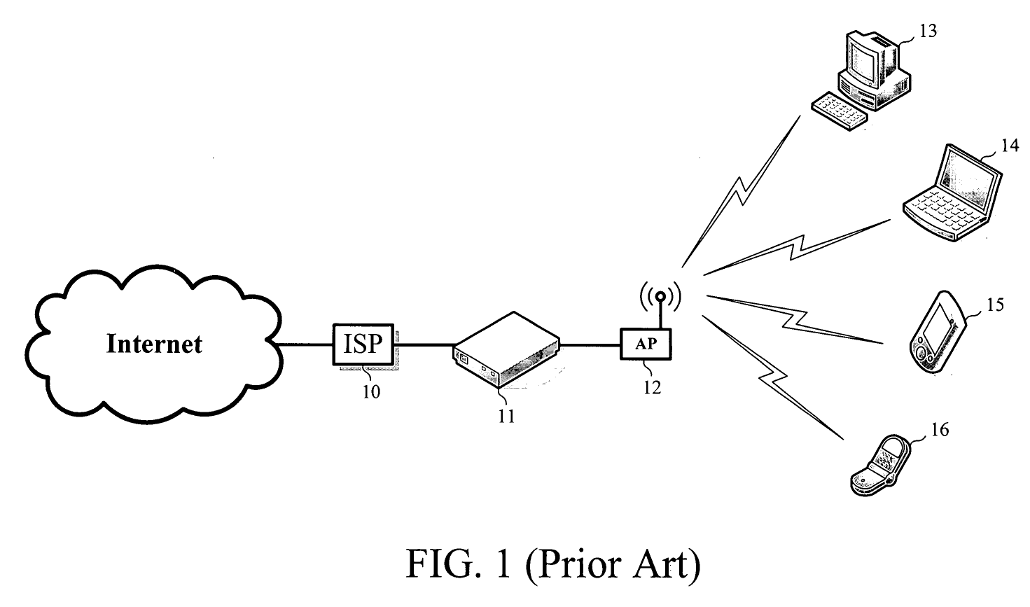

FIG. 2A shows an existing CATV architecture.

FIG. 2B shows the prior art which integrates Ethernet signals in an existing CATV architecture.

FIG. 3 shows the dual-function transmitting system according to the first preferred embodiment of this invention.

FIG. 4A and FIG. 4B show the front and back appearances of the signal provider in actual applications, respectively.

FIG. 5 shows the dual-function transmitting system according to the second preferred embodiment of this invention.

### DETAILED DESCRIPTION OF THE INVENTION

The main purpose of this invention is providing a dual-function transmitting system capable of transmitting CATV signals and wireless network signals simultaneously.

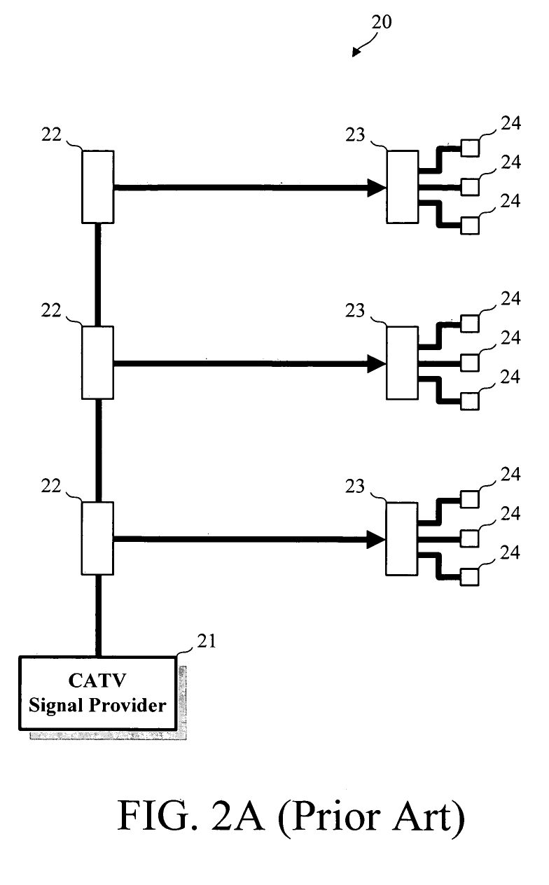

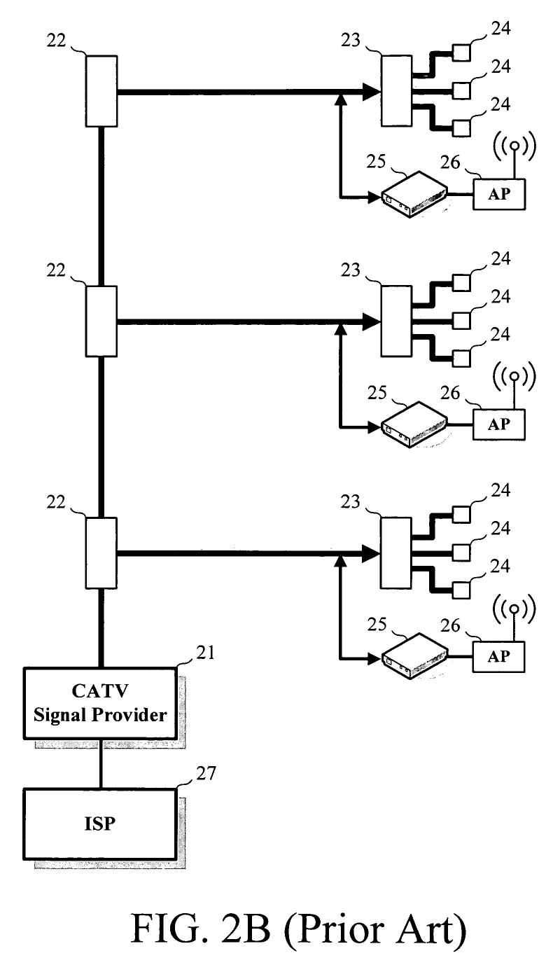

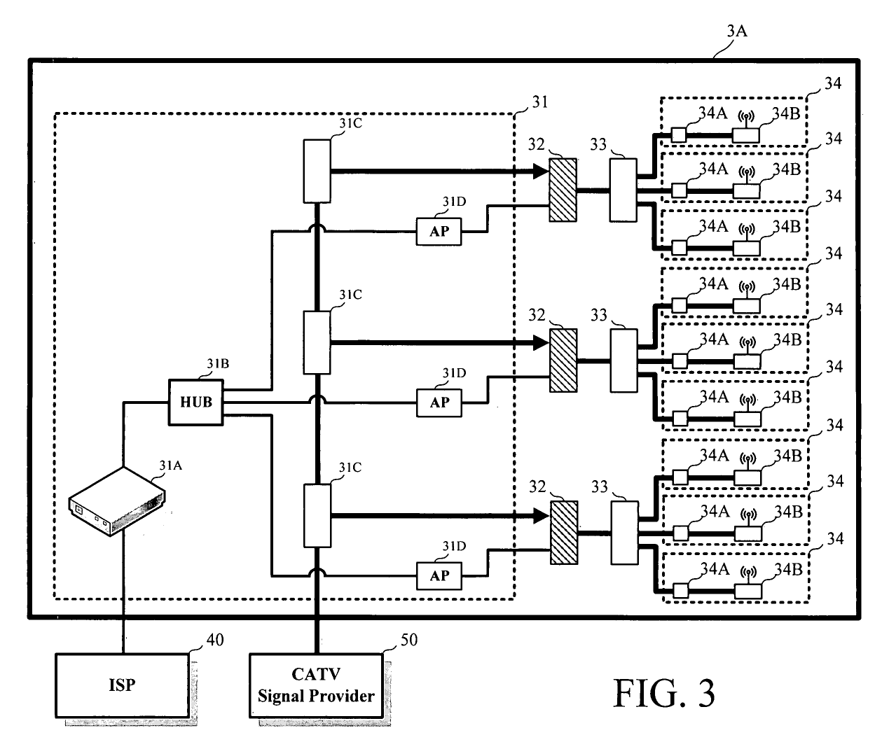

Please refer to FIG. 3. FIG. 3 shows the dual-function transmitting system according to the first preferred embodiment of this invention. The dual-function transmitting system 3A is integrated in the CATV architecture as shown in FIG. 2A. The dual-function transmitting system 3A includes a receiving module 31, N combining modules 32, N transmitting modules 33, and M signal providers 34. N and M are both natural numbers, and M is larger than or equal to N.

The receiving module is used for receiving the Ethernet signal provided by ISP 40 and the CATV signal provided by the CATV signal provider 50. The receiving module then transforms the Ethernet signal into a RF signal conforming to a wireless transmitting protocol, such as, IEEE 802.11a, IEEE 802.11b, or IEEE 802.11g. One thing to be noted is that in the dual-function transmitting system 3A, the receiving module 31 transmits the RF signal to each combining module 32 by coaxial cables. Each of the N combining modules 32 combines the CATV signal and the RF signal from the receiving module 31 to generate a combined signal, respectively. The function of the transmitting module 33 is similar to that of the second signal splitter 23 in FIG. 2A or FIG. 2B. Each of the N transmitting modules 33 is coupled to one corresponding combining module 32 and transmitting the combined signal received from the corresponding combining module 32. Each of the M signal providers is coupled to one corresponding transmitting module 33, receives the combined signal transmitted from the corresponding transmitting module 33, and providing the CATV signal and the RF signal included in the combined signal, respectively.

In the dual-function transmitting system 3A according to this invention, each combining module 32 includes a first input end, a second input end, and an output end. The input impedance of the first input end is equivalent to a first band-pass filter with center frequency roughly equal to the frequency of the RF signal. The first input end is used for receiving the RF signal transmitted from the receiving module 31. The input impedance of the second input end is equivalent to a second band-pass filter with center frequency roughly equal to the frequency of the CATV signal. The second input end is used for receiving the CATV signal transmitted from the receiving module 31. The input impedance of the output end is equivalent to a third band-pass filter with bandwidth covering the frequency of the RF signal and the frequency of the CATV signal. The output end is used for connecting the transmitting module 33 corresponding to the combining module 32. With the impedance characteristics above, each combining module 32 can provide the RF signal and the CATV signal simultaneously.

In actual applications, the signal provider 34 may include a CATV wall box 34A and a dual-output wall box 34B. The CATV wall box 34A is equivalent to the wall box 24 shown in FIG. 2A. After receiving the combined signal from the CATV Wall box 34A, the dual-output wall box 34B provides the RF signal and the CATV signal simultaneously.

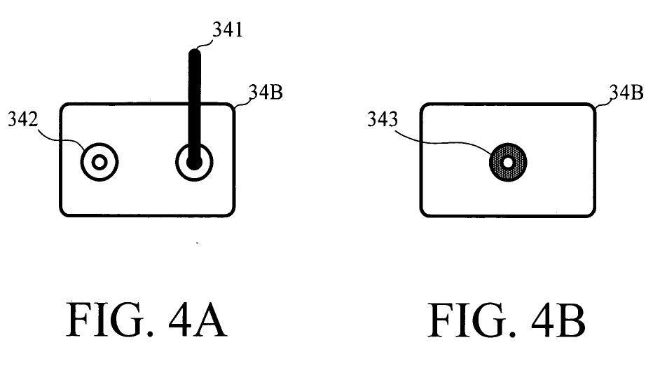

Please refer to FIG. 4A and FIG. 4B. FIG. 4A and FIG. 4B respectively shows the front and back appearance of the dual-output wall box 34B in actual applications (the back side mentioned here is the side that the dual-output wall box 34B adjacent to the CATV wall box 34A). Each dual-output wall box 34B can include an antenna 341 for providing the RF signal, an output connector 342 for providing the CATV signal, and a receiving connector 343. The antenna 341 and the output connector 342 are located at the front side of the dual-output wall box 34B; the receiving connector 343 is located at the back side of the dual-output wall box 34B. The receiving connector 343 is used for receiving the combined signal transmitted from the CATV wall box 34A. The RF signal provided by the antenna 341 is the wireless network signal. To provide signals with better quality, each dual-output wall box 34B can further include a first filter and a second filter. The first and second filter respectively receives the combined signal transmitted from the CATV wall box 34A. The first filter filters out the CATV signal from the combined signal and is coupled to the antenna for providing the RF signal; the second filter filters out the RF signal from the combined signal and is coupled to output connector for providing the CATV signal. Actually, the CATV wall box 34A and the dual-output wall box 34B can also be integrated as one single module.

In the dual-function transmitting system 3A according to this invention, each of the N transmitting modules 33 is coupled to the corresponding combining module 32 via coaxial cables and each of the M signal providers 34 is also coupled to the corresponding transmitting module 33 via coaxial cables.

In actual applications, the combining module 32 can be integrated with the transmitting module 33. As shown in FIG. 3, the receiving module 31 may includes an ADSL modem 31A, a hub 31B, a plurality of first signal splitters 31C, and a plurality of APs 31D.

The ADSL modem 31A is used for assisting the dual-function transmitting system 3A to communicate with the ISP 40. The hub 31B is used for integrating the signals of each AP 31D. The function of the first signal splitters 31C is the same as that of the first signal splitters 22 in FIG. 2A, i.e. transmitting the CATV signal provided by the CATV signal provider 50 to one corresponding combining module 32. Each AP 31D respectively transforms the Ethernet signals transmitted form the hub 31B into a RF signal and provides the RF signal to one corresponding combining module 32.

Compared with the CATV architecture 20 shown in FIG. 2, the dual-function transmitting system 3A additionally includes the ADSL modem 31A, the hub 31B, and the APs 31D. After integrating the WLAN equipment in the CATV architecture 20, the dual-function transmitting system 3A can not only transmits the original CATV signals, but can also transmit/receive wireless network signals. The dual-function transmitting system 3A solves the problem of needing plural APs at contiguous spaces. Contrary to the prior art in FIG. 2B, this invention uses less devices and thus saves much cost in hardware.

The signal provider 34 according to this invention is only to add one dual-output wall box 34B on an existing CATV box 34A and the signal provider 34 has the same function as an AP. Obviously, the signal provider 34 is much cheaper than typical APs. As shown in FIG. 3, if the dual-function transmitting system according to this invention is adopted, each floor or one large single house can share one AP 31D. The signal providers 34 can transmit wireless network signals to each space that needs WLAN services. Accordingly, the dual-function transmitting system according to this invention is a convenient and inexpensive method for providing CATV signals and wireless network signals simultaneously.

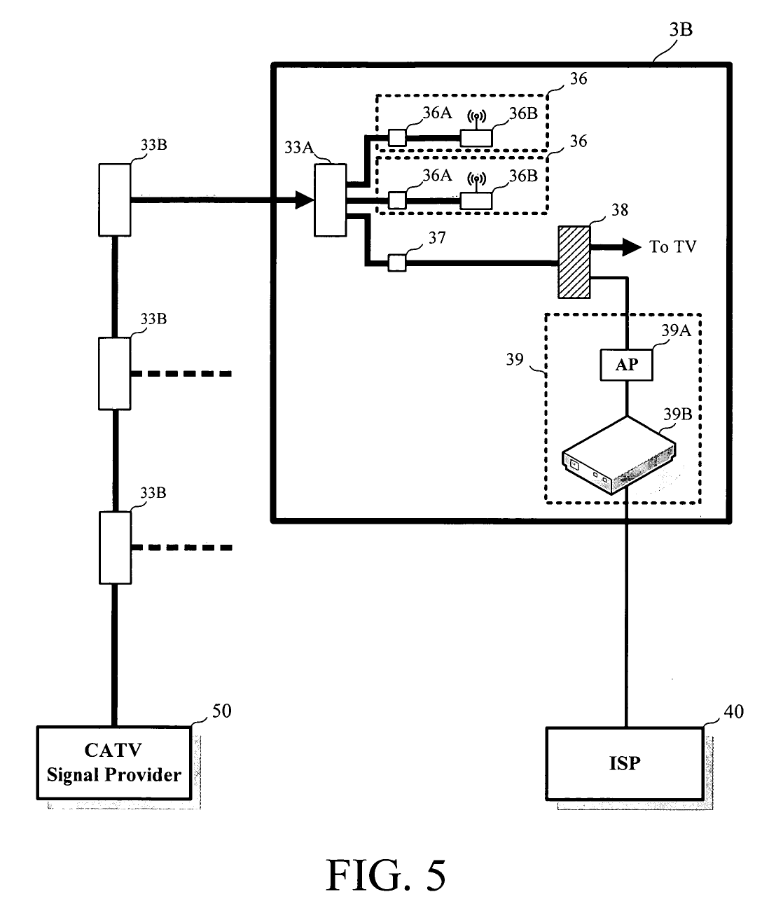

Please refer to FIG. 5. FIG. 5 shows the dual-function transmitting system 3B according to the second preferred embodiment of this invention. The main difference between the first and second preferred embodiments is that the former is more suitable for a whole building or a large space and the latter is more suitable for a single family house with several rooms. The dual-function transmitting system 3B is also integrated in existing CATV architectures as shown in FIG. 2A. The dual-function transmitting system 3B includes a receiving module 39, a combining module 38, a first signal provider 37, at least one second signal provider 36, and a transmitting module 33A.

In the part of transmitting CATV signals, the transmitting module 33A is used for receiving the CATV signal provided by the CATV signal provider 50 and for respectively transmitting the CATV signal to the first signal provider 37 and the second signal providers 36. After receiving the CATV signal transmitted from the transmitting module 33A, the first signal provider 37 provides the CATV signal to users via the combining module 38; the second signal providers 36 provides the CATV signal to users directly.

In the part of transmitting Ethernet signals, the receiving module 39 is used for receiving an Ethernet signal, transforming the Ethernet signal into a RF signal, and transmitting the RF signal to the combining module 38. After receiving the RF signal, the combining module 38 transmits the RF signal to the first signal provider 37. After receiving the RF signal provided by the combined module 38, the first signal provider 37 transmits the RF signal to each second signal provider 36 via the transmitting module 33A. By the aforementioned method, the first signal provider 37 and the second signal providers 36 can all provide the RF signal to users.

As shown in FIG. 5, the receiving module 39 may includes an ADSL modem 39B and an AP 39A. The ADSL modem 39B is used for assisting the dual-function transmitting system 3B to communicate with the ISP 40. The AP 39A transforms the Ethernet signals transmitted form the ADSL modem 39B into a RF signal and provides the RF signal to the combining module 38.

In actual applications, the first signal provider 37 is equivalent to the CATV wall box 34A shown in FIG. 3. As shown in FIG. 5, each second signal provider 36 may include a CATV wall box 36A and a dual-output wall box 36B. The CATV wall box 36A is equivalent to the CATV wall box 34A in FIG. 3; the dual-output wall box 36B is equivalent to the dual-output wall box 34B in FIG. 3.

The combining module 38 in FIG. 5 is similar to the combining module 32 in FIG. 3; each combining module 38 also includes a first input end, a second input end, and an output end. The difference between the combining module 38 and 32 is the connection topology with other devices. The input impedance of the first input end is equivalent to a first band-pass filter with center frequency roughly equal to the frequency of the RF signal. The first input end is used for receiving the RF signal transmitted from the receiving module 39. The input impedance of the second input end is equivalent to a second band-pass filter with center frequency roughly equal to the frequency of the CATV signal. The second input end is used for providing CATV signals to users. The input impedance of the output end is equivalent to a third band-pass filter with bandwidth covering the frequency of the RF signal and the frequency of the CATV signal. The output end is connected to the first signal provider 37 and provides the combined signal that includes the RF signal and the CATV signal to the first signal provider 37.

In actual applications, the first signal provider 37 and each second signal provider 36 may be located in different rooms of a single family house. As shown in FIG. 5, a single family house needs only one AP to provide wireless signals in all spaces.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A dual-function transmitting system comprising:
a receiving module for receiving a CATV (cable TV) signal and an Ethernet signal and then transforming the Ethernet signal into a RF signal;
N combining modules respectively coupled to the receiving module, each of the N combining modules combining the CATV signal and the RF signal from the receiving module to generate a combined signal, respectively, wherein N is a natural number;
N transmitting modules, each of the N transmitting modules being coupled to one corresponding combining module and transmitting the combined signal received from the corresponding combining module; and
M signal providers, each of the M signal providers being coupled to one corresponding transmitting module, receiving the combined signal transmitted from the corresponding transmitting module, and providing the CATV signal and the RF signal comprised in the combined signal, respectively, wherein M is a natural number equal to or larger than N.

2. The dual-function transmitting system of claim 1, wherein the RF signal is in accordance with IEEE 802.11a, IEEE 802.11b, or IEEE 802.11g specification.

3. The dual-function transmitting system of claim 1, wherein each of the N transmitting modules is coupled to the corresponding combining module via coaxial cables and each of the M signal providers is coupled to the corresponding transmitting module via coaxial cables.

4. The dual-function transmitting system of claim 1, wherein each combining module comprises:
a first input end whose input impedance is equivalent to a first band-pass filter with center frequency roughly equal to the frequency of the RF signal;
a second input end whose input impedance is equivalent to a second band-pass filter with center frequency roughly equal to the frequency of the CATV signal; and
an output end whose input impedance is equivalent to a third band-pass filter with bandwidth covering the frequency of the RF signal and the frequency of the CATV signal;
wherein the first input end is used for receiving the RF signal transmitted from the receiving module, the second input end is used for receiving the CATV signal transmitted from the receiving module, and the output end is used for connecting the transmitting module corresponding to the combining module.

5. The dual-function transmitting system of claim 1, wherein each of the M signal providers comprises an antenna for providing the RF signal and an output connector for providing the CATV signal.

6. The dual-function transmitting system of claim 5, wherein each signal provider further comprises a first filter and a second filter, the first and second filter respectively receives the combined signal transmitted from the transmitting module, the first filter filters out the CATV signal from the combined signal and is coupled to the antenna for providing the RF signal, the second filter filters out the RF signal from the combined signal and is coupled to output connector for providing the CATV signal.

7. The dual-function transmitting system of claim 1, wherein the receiving module comprises:
N access points, each of the N access points being coupled to one corresponding combining module and providing the Ethernet signal to the corresponding combining module, respectively.

8. A dual-function transmitting system comprising:
a receiving module for receiving an Ethernet signal and transforming the Ethernet signal into a RF signal;
a transmitting module for receiving a CATV (cable TV) signal and transmitting the CATV signal;
a first signal provider for receiving and providing the CATV signal transmitted by the transmitting module;
at least one second signal provider for receiving and providing the CATV signal transmitted by the transmitting module; and
a combining module for receiving the RF signal from the receiving module, transmitting the RF signal to the first signal provider, and for receiving and transmitting the CATV signal provided by the first signal provider;
wherein after receiving the RF signal transmitted from the combining module, the first signal provider transmitted the RF signal to the transmitting module, and after receiving the RF signal transmitted from the first signal provider, the transmitting module transmits the RF signal to the at least one second signal provider.
